(19) United States
(12) Patent Application Publication
(10) Pub. No.: US 2022/0115978 A1
(43) Pub. Date: Apr. 14, 2022

(54) SOLAR ASSISTED ELECTRIC TRANSPORTATION

(71) Applicant: Yehoshua FISHLER, Shoham (IL)

(72) Inventor: Yehoshua FISHLER, Shoham (IL)

(21) Appl. No.: 17/428,336

(22) PCT Filed: Feb. 5, 2020
(86) PCT No.: PCT/IB2020/050939

§ 371 Date: Aug. 4, 2021

Related U.S. Application Data
(60) Provisional application No. 62/801,328, filed on Feb. 5, 2019.

(51) Int. Cl. H02S 20/21; B60L 53/51

(52) U.S. Cl. CPC H02S 20/21; H02J 3/381; B60L 53/51

(57) ABSTRACT

A transportation pathway, such as a railway or roadway, has a plurality of poles supporting electrical wires. The poles extend in a line parallel to the transportation pathway. In a railway, the poles support a power cable to supply power to an electric train or tram. In a roadway, the poles have electrical wires for street lights. Solar panels extend between the poles and provide power to the train, tram or street light, or support an outlet for recharging electric vehicles. The power generated by the solar panels can be used to supplement or replace the power provided through the poles. Power not used in this manner can be stored in a battery or sent into the electric grid. The solar panels can be retrofit onto existing systems.

### CROSS REFERENCE TO RELATED APPLICATIONS

This application claims benefit to U.S. 62/801,328, filed Feb. 5, 2019, the entire contents of which are hereby incorporated by reference.

### BACKGROUND OF THE INVENTION

Some train services operate over lines using more than one type of current. In cities such as London, New York City and Boston, the same trains run under overhead wires for part of the journey and use a third rail for the remainder. In Europe, some locomotives are equipped to operate under four voltages—25 kV AC, 15 kV AC, 3,000 V DC and 1,500 V DC. Modern electronics makes this possible with relative ease and cross voltage travel is now possible without changing locomotives.

The Israel Railways authority is constructing an improved electrified rail line from Tel Aviv to Jerusalem. The line will begin as an extension of the current railway to Ben-Gurion Airport and Modi'in-Maccabim-Re'ut, and will terminate in a new underground station beside the Jerusalem Central Bus Station. In Europe, the recommended geometry and shape of pantographs are defined by standard EN 50367/IEC 60486. Providing recharging capabilities for electric vehicles is currently a problem. The problem currently for fast charging is the weak power connection of street light circuits to the grid. The problem currently for fast charging is the weak power connection of street light circuits to the grid. The existing lighting connection for the whole street is weak, with that only one car will be fill in the morning if you plug it in at night with slow charging, and weak down the lights.

Power generated in remote power stations pass through large and complex networks which include transformers, overhead lines, cables and other equipment to reaches the end users (such as electric trains and trolleys. The electric energy generated by a power station in either distant traditional power stations or remote photovoltaic power stations do not equal the amount of energy which is delivered to the locomotive due to transmission and distribution loss in the electrical grid connecting the power station and electric train or trolley. The transmission and distribution loss are calculated as the difference between the energy input to the electric grid and the amount of energy reaching the ultimate consumer. Transmission Losses are approximate 17% while Distribution Losses are approximate 50%.

There are two types of two types of losses for the T transmission and distribution losses in a power system: technical Losses (TL) and non-technical losses (NTL & Commercial Losses). The amount of power that can be sent over a transmission or over a distribution line is limited, and avoiding the transmission of power over the grid reduces transmission and distribution loss. In addition, generating solar power close to the place of use reduces pollution associated with traditional power generation.

### SUMMARY OF THE INVENTION

A method and system for solar power generation and energy distribution offsets the power demand of an electric system. The photovoltaic system may have a power generation capacity of any size. This system can be materialized on any existing electric power distribution grid and enhance electric transportation. Lightweight flexible solar panels having flexible membranes are deployed on top of the existing overhead power distribution system, to create a photovoltaic panel system for power generation enhancing the transportation power distribution grid of the transportation system.

The photovoltaic system is applied to overhead cables which are already available for electric trains, electric trams and electric buses. The method and system also applies to charging the batteries of electric cars. A substantial advantage surfaces when the cars are parked on the street, and the charging will be from the lighting poles or other power distribution system end point. Photovoltaic panels are deployed on top of the existing power cables extended between the poles such as the lighting poles. Flexible solar modules extend along the space between the existing poles of electrical trains, supplementing photovoltaic generation to the train electrification system. This integration generation in an unused space and will produce electricity closest to the load site.

The power generated by the photovoltaic system, can be used in the event of failure of the power received from the electric grid. In addition, the electric grid currently needs to supply power at the peak value needed by the electric train or bus, even when the actual power is below the peak value a majority of the time. By supplementing the power received from the grid, the power generated by the photovoltaic system allows the power grid to only provide less than the peak value, with the photovoltaic system providing the difference during the limited time when peak value is required. The photovoltaic system can also send unused power into the grid and reduce cost of operation because of the reduced transmission and distribution loss is realized by the power being used close to the point of generation.

A transportation system includes a transportation pathway, a plurality of poles extending in a line parallel to the transportation pathway, the plurality of poles receiving electrical power from an electric grid and at least one solar panel extending between two poles of the plurality of poles.

The transportation pathway is a railway or the transportation pathway is a roadway.

The transportation system has a primary transformer between the electric grid and the plurality of poles and a secondary transformer between the at least one solar panel and the transportation pathway.

The at least one solar panel is flexible and the at least one solar panel comprises at least one solar panel between each pair in the plurality of poles.

A transportation system includes a transportation pathway, a plurality of poles extending in a line parallel to the transportation pathway, the plurality of poles supporting electrical power lines from an electric grid and at least one solar panel extending between two poles of the plurality of poles.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a schematic view of a system supplying power from an electric grid and a solar cell to a transportation path;

FIG. 2 depicts a railway having flexible solar panels extending between the poles providing electricity from an electric grid;

FIG. 3 depicts a roadway having flexible solar panels extending between the poles providing electricity from an electric grid;

FIG. 4 depicts the charging of an electric vehicle.

### DETAILED DESCRIPTION OF THE INVENTION

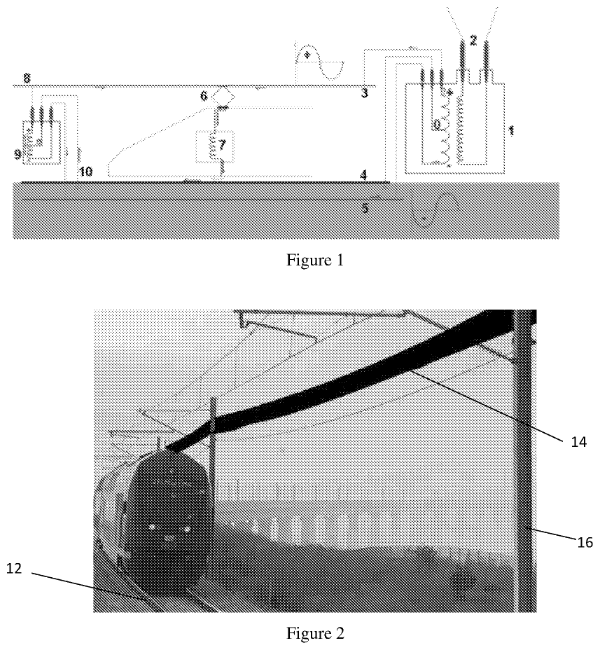

FIG. 1 depicts the power feeding system and the autotransformer connecting circuit which is a common concept for power supply to the railway electrification grid in many places. This means providing power in parallel from two sources; from a conventional power plant to a main transformer 1 and from solar panels to the secondary transformer 9. A photovoltaic power source 8 is connected at the transformer 9 for raising the voltage and has a connection 3 for injecting electric power to the grid in remote locations. The transformer has a connection 10 for supplying power to a railway 4.

Broadly speaking, the invention comprises a transportation pathway and a plurality of poles aligned parallel to the transportation pathway. The solar panels, preferably flexible, extend between poles in an electric distribution system, such as used to power electric trains or trams or support power lines along streets. The poles receive power from an electrical grid. A plurality of solar panels extend between the plurality of poles and provide electrical power to the poles as a secondary source of power. The transportation pathway may be a rail way for a train or tram or the transportation pathway may be a road. The solar panels can be retrofit onto existing poles extending along railways and roadways.

Flexible solar panels are mounted on a flexible sheet in the air between the electrical poles near the load as alternative to remote solar plant farms that require investment in infrastructure for its construction and to conduct the generated power and to bear considerable electricity losses on the way. Based on the dimensions of the panels (about 5 mtr) and the electrical specifications of the panels, an electrical scheme of each section will be drawn between columns, and a geometric arrangement on the flexible sheet, and measurements and weights and wind forces will dictate the structure and reinforcement of the base sheet.

A suitable base sheet having a suitable length and thickness to support the solar cells according to the geometrical arrangement of the panels on the appropriate base sheet, the length of the width of the thickness of the material type shall be determined, as well as pigment and resistance to the sun. Stability and prevention of fluttering based on dynamic calculation of lift and whirlwind forces and matching of thrillers will be done with a combination of “hardening and weight” hardeners inside the sheet and on cables to strengthen and eliminate vibrations. An appropriate material for the base sheet need stability over time, resistance to sun, transparency and shade suitable for good visibility, suitable plate fitting properties, strength in tensile strength and flutter, and self weight. A suitable material includes PVC and its derivatives like ELVA. Flexible solar panels are lightweight and very flexible, making them easy to integrate on the cables, while offering no wind load and stable under high winds because it blends into the membrane as well as superior energy yield of proven performance under high heat and non-ideal illumination.

An accumulator battery, either extended on the panel or a box type installed on or aside the pole, can be adjusted to the usage profile, including charge rate and discharge. When the battery is connected to the flexible panels and the electrical assembly, the battery parameters are matched to the voltage in the section. Data is collected on the profile of the railroad's operation and on actual electricity rates to determine the best discharge profile for the electric tram system, including demand reduction and frequency regulation.

A measurement and counting system identifies a real-time reactive consumption profile and the management of a bi-directional system for efficient power supply with remote control and for protection against overvoltage and over-current uninterrupted bidirectional power supply in contrast to directional unstable non interactive system without backup which depends on the limitations of the transmission and distribution loads of the AC in other locations.

An auto transformer stabilizes and raises and lowers the input and output voltage for the electrification system, in contrast to an initial transformer system which experiences stress reductions and without voltage management and volatility.

The system may utilize existing infrastructure with right of way for deployment of solar panels, reducing environmental footprint weight, and cost and making more efficient use of materials and space. The solution enables dynamic, automated, and cost effective management of the traction power network. Injecting on demand electricity to the traction power network, very close to the location where the load exists, therefore the Sol-generator stabilizes the traction power network. Finally, the photovoltaic installation would be able to share the security and maintenance infrastructure already available at the rail authority, while the electricity from the system is directly used for the locomotive, reducing load on the utility grid.

FIG. 2 depicts a railway 12 having a plurality of poles 14 extending parallel to the railway. The poles are connected to an electrical grid to provide power to the train. Solar panels 16 extend between each of the poles and also provide electrical power to supplement or replace the power provided by the grid. If no train is travelling on the railway, the power from the solar panels can be stored in batteries or sent into the grid. Preferably, flexible photovoltaic solar panels extend between electrical poles on the electricity grid and a system of storage and retrieval of electric charge installed on the electricity poles of the grid. The system also includes a parallel and independent electrical feed assembly for a control and counting system and a method of measurement and an electricity meter. A transformer allows for lifting and lowering of voltage generated by the solar panels. An electrical switching system connects the dual power sources to supply power from a single source or both sources.

The solar assisted electric train model will outperform (by cutting the losses) on the existing state of the art model of an electric train by installing the panels in close proximity to where the locomotive draws power. The solar assisted electric train model exhibits lower capital expenditure when compared to the capital expenditure of the state of the art photovoltaic systems, mainly by saving on installation cost.

Deploying flexible photovoltaic panels on top of the traction power network, and reducing the regulatory, normative and administrative barriers hampering the large-scale integration of photovoltaic power into the traction power network, enables consolidation of the photovoltaic power generation with the traction power supply on the same right of way in an extremely efficient way.

The solar assisted electric train model saves costs by avoiding the need to ramp up the power transmission and distribution capacity of the existing utility transmission grid and by minimizing the power losses mainly in the lower voltage due to shorter distance from the power generation point to the load.

The solar assisted electric train model is a unique application enabling in real time utility scale timely photovoltaic power injection in parallel to the power supplied from the base load source in the correct location by the exact photovoltaic solar power intensity therefore stabilizing the traction power network and the DS.

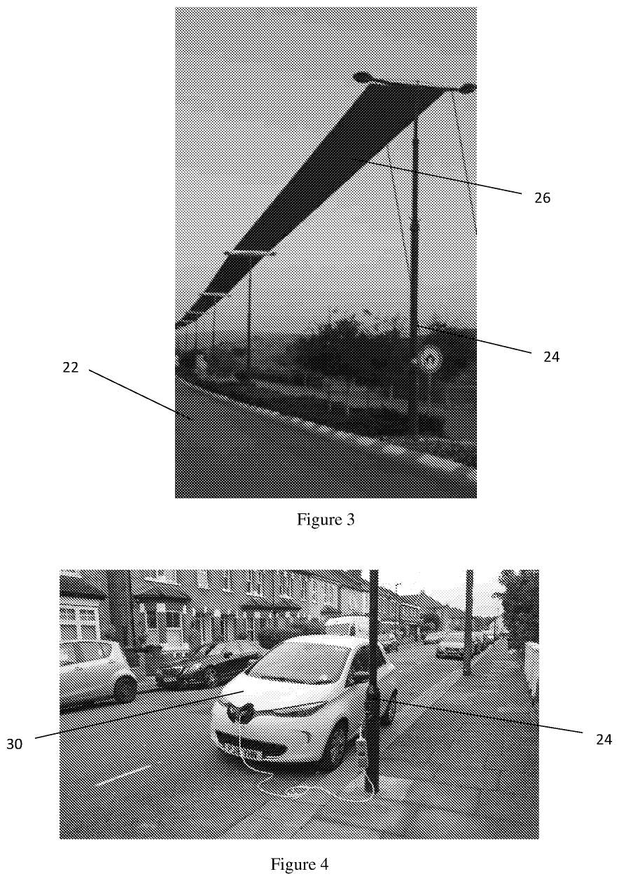

FIG. 3 depicts a roadway 22 having solar panels 26 extending between poles 24. The poles receive power from an electrical grid to power lights at the top of the pole. Providing the solar panels will not only enable the solar energy to be used to power the lights, but the solar panels would generate enough power to enable charging of electric vehicles. An outlet at the base of the pole would allow the attachment of a charging cord that can be used to charge an electric vehicle, such as depicted in FIG. 4, depicting an electric vehicle 30 receiving power through an outlet in pole 24. Similar to the railway having the solar panels, any excess energy generated by the solar panels can be stored in a battery system or transmitted into the electric grid.

Currently, existing light poles do not have sufficient power to rapidly charge a large number of cars, often having difficulty in charging a single electric vehicle in an acceptable amount of time. The additional power provided by the solar panels enables a greater number of vehicles to be charged in a shorted amount of time. Charging will be also smart, the charging cables will be designed to work both ways in the future, nearby parking cars could help store energy and share with neighboring cars, and feed power back into the grid as it's required. The proximity between the cars will allow the distribution of electric charge between cars close to the system as a whole will also serve as an electricity reservoir. The suggested solution adopted to the pole system circuit will easily provide 22 Kwt connection or other sized connection per each charging point, possibly every second pole. As technology progresses and electric vehicles are capable of being charged in a shorter amount of time, this ability will increase in importance.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A transportation system, comprising:
a transportation pathway;
a plurality of poles extending in a line parallel to the transportation pathway, the plurality of poles receiving electrical power from an electric grid; and
at least one solar panel extending between two poles of the plurality of poles.

2. The transportation system of claim 1, wherein the transportation pathway is a railway.

3. The transportation system of claim 1, wherein the transportation pathway is a roadway.

4. The transportation system of claim 1, further comprising a primary transformer between the electric grid and the plurality of poles; and
a secondary transformer between the at least one solar panel and the transportation pathway.

5. The transportation system of claim 1, wherein the at least one solar panel is flexible.

6. The transportation system of claim 1, wherein the at least one solar panel comprises at least one solar panel between each pair in the plurality of poles.

7. A transportation system, comprising:
a transportation pathway;
a plurality of poles extending in a line parallel to the transportation pathway, the plurality of poles supporting electrical power lines from an electric grid; and
at least one solar panel extending between two poles of the plurality of poles.

8. The transportation system of claim 7, wherein the transportation pathway is a railway.

9. The transportation system of claim 7, wherein the transportation pathway is a roadway.

10. The transportation system of claim 7, further comprising a primary transformer between the electric grid and the plurality of poles; and
a secondary transformer between the at least one solar panel and the transportation pathway.

11. The transportation system of claim 7, wherein the at least one solar panel is flexible.

12. The transportation system of claim 7, wherein the at least one solar panel comprises at least one solar panel between each pair in the plurality of poles.
